(19) United States
(12) Patent Application Publication
(10) Pub. No.: US 2023/0406388 A1
(43) Pub. Date: Dec. 21, 2023

(54) ELECTRICAL POWER ASSIST FOR WHEELED CHILD CARRIER

(71) Applicant: Evenflo Company, Inc., Miamisburg, OH (US)

(72) Inventors: FENG LIU, Kunshan City (CN); JIAFENG GUO, Kunshan City (CN); JINLONG LIAN, Kunshan City (CN)

(21) Appl. No.: 18/211,335

(22) Filed: Jun. 19, 2023

(30) Foreign Application Priority Data
Jun. 20, 2022 (CN) CN 202221545969 U

(51) Int. Cl. B62B 5/00

(52) U.S. Cl. CPC B62B 5/0066; B62B 7/04; B62B 5/0046; B62B 5/0043

(57) ABSTRACT

Embodiments of an electric power-assisted wheeled child carrier are provided herein. The electric power-assisted wheeled child carrier, such as a stroller for example, includes an electric drive mechanism for electrically powering rotation of at least one wheel of the child carrier. The electric power mechanism includes a motor, an output shaft coupled to the motor that is configured to rotate the output shaft, a wheel shaft coupled to the wheel being powered; and a clutch positioned between the output shaft and the wheel shaft. The clutch is configured to move axially between an engaged state and a disengaged state. In the engaged state, the output shaft powered by the motor drives rotation of the wheel, and in the disengaged state, the wheel is configured to rotate without power from the motor.

### CROSS-REFERENCE TO RELATED APPLICATIONS

This application claims priority to Chinese Utility Model Patent Application Number CN202221545969U, filed Jun. 20, 2022, the entirety of which is hereby incorporated by reference.

### TECHNICAL FIELD

The present disclosure relates generally to wheeled child carriers, such as strollers or wagons, in particular to an electric power-assisted a wheeled child carrier.

### BACKGROUND

Wheeled child carriers, like strollers and wagons, can be laborious to push, particularly with older children, multiple children, and/or when carrying additional items. Electrical assists on such wheeled carriers can reduce or eliminate the force needed for the user to push the wheeled carrier. Existing power-assisted carriers include right and left sides driven by separate motors so that two motors are required, which increases the weight of the carrier. Additionally, the motors in existing power-assisted carriers provide resistance when the user desires or needs to become the driving force and push or pull the carrier manually. Further, different motors for the right and left wheels requires multiple sensors and related control circuits to enable steering, such as setting an angle sensor to detect the rotation angle of another wheel and then control the circuit according to detected angle to change rotational speed of the motor(s) on other wheels. This method not only increases the cost of the cart, but also has the disadvantages of complex control circuit design and poor control effect

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIG. 1 is a rear perspective view of an example electric power-assisted child carrier in accordance with an embodiment of the present disclosure;

FIG. 2 is a side view of the electric power-assisted child carrier of FIG. 1 in accordance with an embodiment of the present disclosure;

FIG. 3 is a close-up review of the electric power-assisted child carrier of FIG. 1 with a cover removed in accordance with an embodiment of the present disclosure;

FIG. 4 is a cross-sectional view along the A-A direction of FIG. 1 when the left clutch and the right clutch are both in the first state in accordance with an embodiment of the present disclosure;

FIG. 5 is a cross-sectional view along the A-A direction of FIG. 1 when the left clutch and the right clutch are both in the second state in accordance with an embodiment of the present disclosure;

FIG. 6 is a partial exploded view of the electric power-assisted child carrier of FIG. 1 in accordance with an embodiment of the present disclosure; and

FIG. 6A is a magnified portion of the partial exploded view of FIG. 6 in accordance with an embodiment of the present disclosure.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part

It should be noted that some of the terms used herein may be relative terms. For example, the terms “upper” and “lower” and the terms “forward” and “rearward” or are relative to each other in location, i.e. an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e. ground level. However, these terms should not be construed to require structures to be absolutely parallel or absolutely perpendicular to each other unless so illustrated or otherwise described. The terms “top” and “bottom” or “base” are used to refer to surfaces where the top is always higher than the bottom/base relative to an absolute reference, i.e. the surface of the earth. The terms “upwards” or “upwardly” and “downwards” or “downwardly” are also relative to an absolute reference; upwards is against the gravity of the earth when the structure is arranged on the ground or surface as intended and illustrated. Additionally, the terms “left” and “right” are used in reference to the direction in which the structure is shown in the drawings, and it is understood that such structures may be on opposite sides when viewed from a different angle. The terms “forward” and “rearward” or “rear” with respect to a position or orientation are opposite one another along a common direction, and an “intermediate” position is always located between a forward position and a rearward position or between a left and right position.

The terms “operative to”, “adapted to”, “configured to” and similar terms are used herein to describe that a particular component has certain structural features designed to perform a designated function. Such components should be construed as having the expressed structure, with the designated function being considered part of the structure. The term “engage” and similar terms are used herein to describe the interaction between particular components and does not necessarily require that such components contact one another (directly or indirectly).

As used herein and as will be appreciated by those skilled in the art, the term “wheeled child carrier” encompasses strollers, wagons, carts, and the like for children, infants, and toddlers. Although embodiments of the disclosure are disclosed with respected to wheeled carriers for children, it will be appreciated that aspects of the disclosure may equally apply to wheeled carriers for adults, animals, or goods without departing from the scope of the disclosure.

It should be noted that the terms “first” and “second” used herein are intended to distinguish from similar objects, which include objects that are not identical but may have similar structures and/or functions. These terms are not necessarily used to describe a specific order or sequence. Furthermore, the terms “comprising” and “having”, as well as any variations thereof, are intended to cover a non-exclusive inclusion, for example, a process, method, means, product or equipment comprising a series of steps or elements need not be limited to the expressly listed instead, may include other steps or elements not explicitly listed or inherent to the process, method, product or apparatus.

Aspects of this disclosure include wheeled child carriers and components thereof with improved electrical power assist features. At a high level, aspects include a system with a motor, right and left clutches that can each selectively engage and disengage with the motor so that the respective wheels receive power assist or no power assist. In this way, when the motor is turned off and is not the driving force of the wheeled child carrier, resistance from the motor on one or both rear wheels can be reduced or eliminated, thereby allowing the child carrier to be pushed or pulled more easily by the user. In example aspects, the left and right clutches work independently one each other so when one clutch is engages and powering the respective rear wheel, another clutch can be disengaged without powering the respective rear wheel.

In one embodiment of the present invention, an electric power-assisted wheeled child carrier 100 is provided. The figures herein illustrate a stroller as an example electric power-assisted wheeled child carrier 100, but it should be appreciated that the components of the wheeled child carrier 100 described herein can be in the form of other types of wheeled carriers, including a wagon.

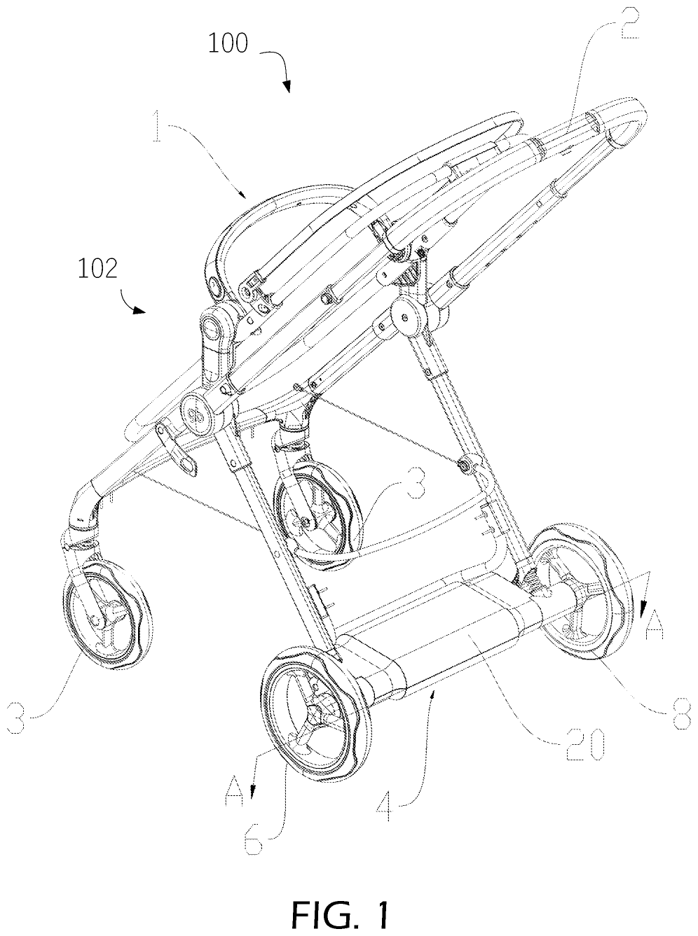

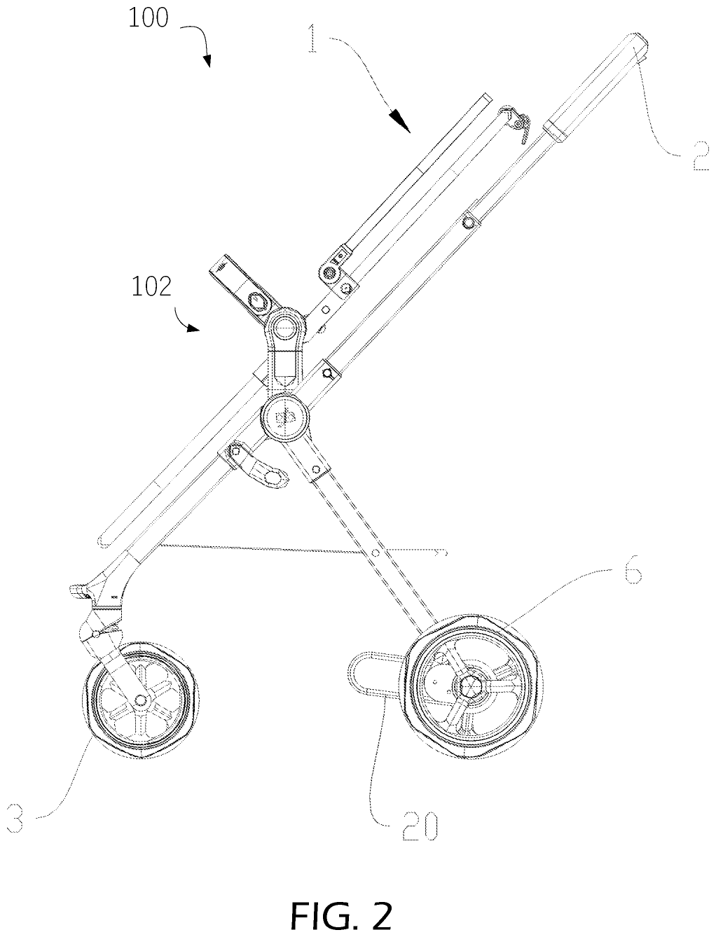

As shown in FIG. 1-3, the wheeled child carrier 100 includes a frame 1 and a handle 2. The handle 2 is arranged at the rear of the frame 1 in this example and may act as a push handle. In other aspects, the handle may be arranged at the front of a carrier, such as a wagon, so that it can be used as a pull handle. In some aspects, the handle 2 may be adjustable so that it can be moved between the front and rear of the frame 1 so that it may be used for push or pull. The wheeled child carrier 100 includes one or more front wheels 3 installed under the front part of the frame 1 for steering the carrier. In the example illustrated, there is a left front wheel and a right front wheel, but in other aspects, there is a single front wheel. The wheeled child carrier 100 further includes rear wheels installed under the rear part of the frame 1. Specifically, the carrier includes a left rear wheel 6 and a right rear wheel 8.

This disclosure refers to left and right rear wheels 6 and 8 and other left and right components generally corresponding to the left and right rear wheels 6 and 8. It should be understood that, unless otherwise stated, example embodiments include such left and right components (including such left and right rear wheels 6 and 8) as having the same or similar structures, such as structures that are mirror images. Similarly, left and right components generally perform similar functions. As such, reference made be made with respect to only a component of one side of the wheeled child carrier 100 but one skilled in the art would understand how such description would be applicable to the corresponding component on the other side.

The wheeled child carrier 100 also includes a seating area 102 configured to accommodate a person, such as a child, and is positioned generally above front wheels 3 and rear wheels 6 and 8. Although not illustrated for simplicity, the wheeled child carrier 100 may include soft goods, such as textiles and cushions, including seating panels and a canopy. The wheeled child carrier 100 may also include a harness, lap belts, or other features not illustrated.

The wheeled child carrier 100 further includes an electric drive mechanism 4, which may also be referred to as an electric drive device, for driving the left rear wheel 6 and right rear wheel 8 to rotate. The electric drive mechanism 4 is installed on the frame 1 and arranged between the left rear wheel 6 and the right rear wheel 8. The electric drive mechanism 4 includes a power source, such as a storage battery, which may be a rechargeable or non-rechargeable battery, installed on the wheeled child carrier 100.

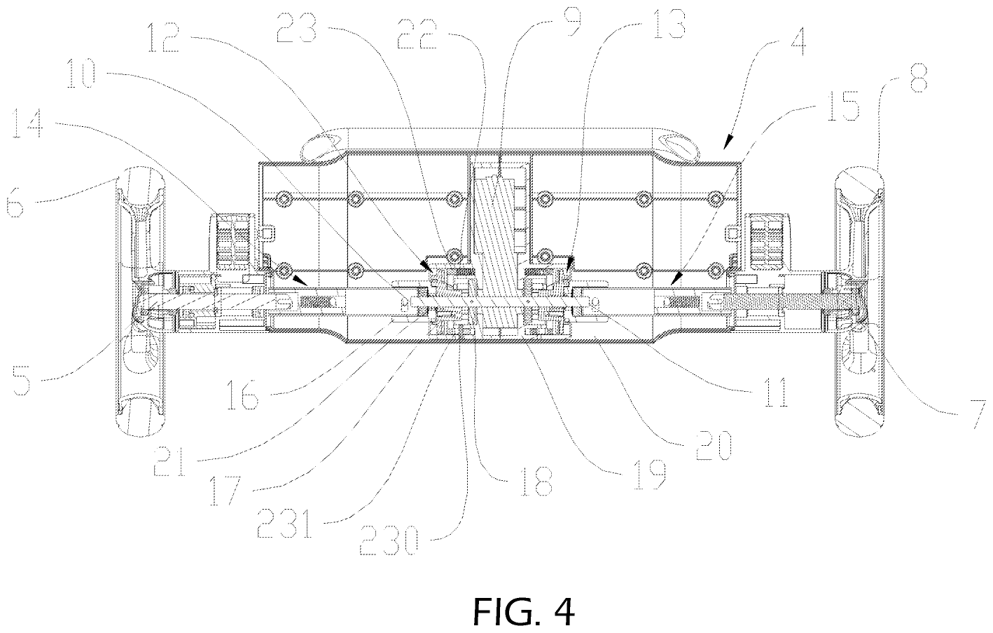

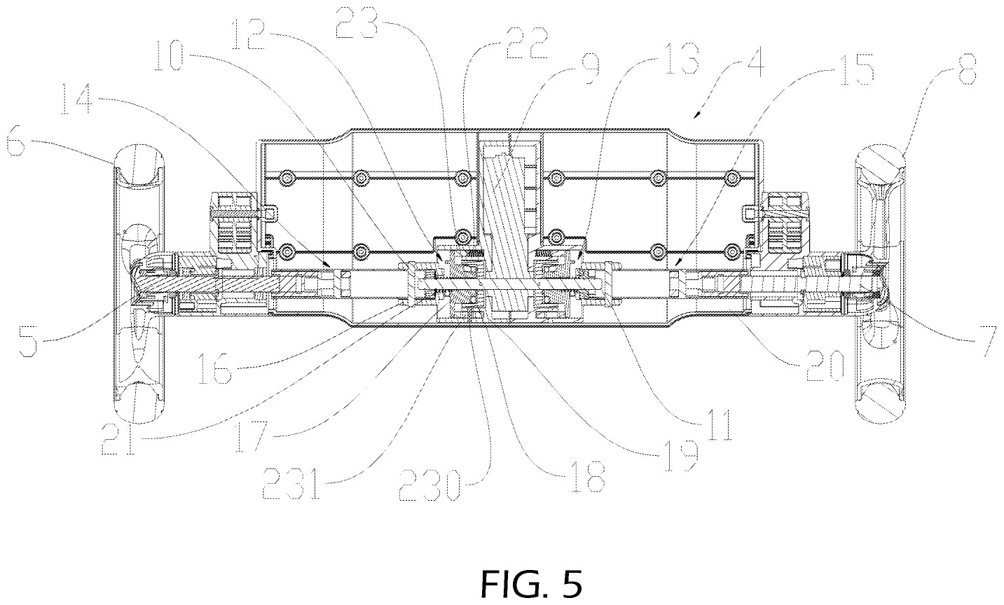

The electric drive mechanism 4 of the wheeled child carrier 100 includes a motor 9. The motor 9 has a rotating state when it is powered on and a stalling state when it is powered off. As shown in FIGS. 4-5, the electric drive mechanism 4 includes a left output shaft 10 (which may also be referred to as the left drive shaft 10) extending from the left side of the motor 9 and a right output shaft 11 (which may also be referred to as the right drive shaft 11) extending from the right side of the motor 9. In some aspects, the left output shaft 10 and the right output shaft 11 are different portions or opposite ends of a single shaft so that movement of one, such as translational movement, causes corresponding movement of the other. In other aspects, the left output shaft 10 and the right output shaft 11 are two distinct shafts but are rigidly connected together to synchronize movement.

Each of the rear wheels 6 and 8 are connected to wheel shafts that, in at least some instances, directly rotate the rear wheels 6 and 8. For example, the left rear wheel 6 is connected to a left rear wheel shaft 5 (which may be referred to herein as the left rear axle 5), and the right rear wheel 8 is connected to a right rear wheel shaft 7 (which may be referred to herein as the right rear axle 7). In example aspects, the left rear wheel shaft 5 and right rear wheel shaft 7 are secured to the central plate or bore of the respective rear wheel. In other aspects, the left and right rear wheel shafts 5 and 7 are secured to the respective wheels at a location along or adjacent the rim of the wheel.

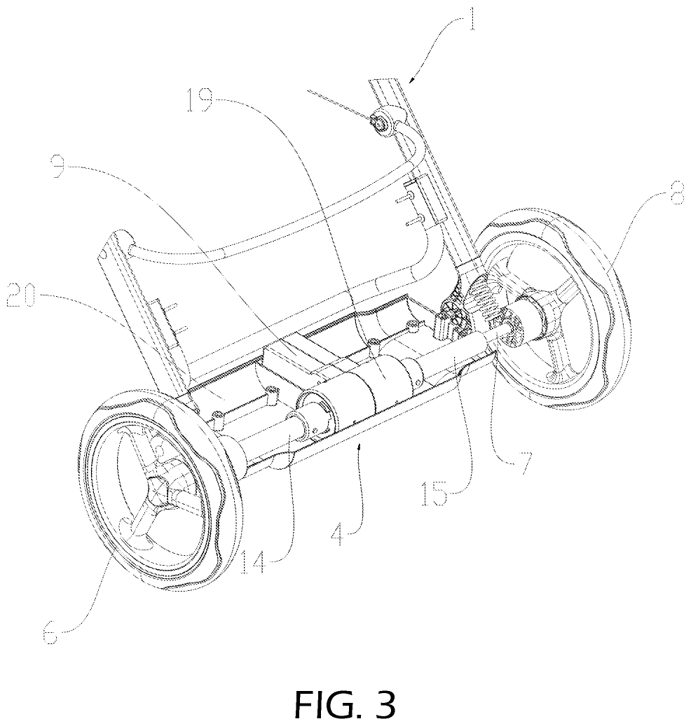

Generally, when the motor 9 is in the rotating state, the left and right output shafts 10 and 11 are rotated by the motor 9 and cause the respective rear wheel shafts 5 and 7 to be rotated, thereby resulting in rotation of the left and right rear wheels 6 and 8. In the embodiment illustrated in FIGS. 3-6, the left output shaft 10, the right output shaft 11, the left rear wheel shaft 5, and the right rear wheel shaft 7 are all arranged coaxially. It should be noted that, in other embodiments, the left output shaft 10 and the right output shaft 11 may also not extend along the same axial direction.

The electric drive mechanism 4 further includes clutches that selectively cause the rear wheels 6 and 8 to be disengaged from motor-based rotation. The left output shaft 10 is connected with the left rear wheel shaft 5 through a left clutch 12. The left clutch 12 may be sleeved on the left output shaft 10, while the right clutch 13 may be sleeved on the right output shaft 11. In some aspects, the left clutch 12 and the right clutch 13 are arranged around at least part of an outer diameter of the respective left output shaft 10 and right output shaft 11 while not necessarily extending around the entire diameters. In other aspects, the left clutch 12 and the right clutch 13 are arranged to extend completely around the outer diameter of the respective left output shaft 10 and right output shaft 11.

In the embodiment shown, the left clutch 12 and the right clutch 13 are provided in a motor housing 19 of the electric motor 9, but it may be appreciated that the clutches 12 and 13 may be provided outside of the motor housing 19 while remaining mechanically linked to the left and right output shafts 10 and 11. Further spatial relationships and mechanical interactions with the left and right output shafts and 11 with the respective left and right clutches 12 and 13 as well as with the respective left and right rear wheel shafts 5 and 7 are discussed further herein.

The left and right output shafts 10 and 11 may also be connected with the respective left and right rear wheel shafts 5 and 7 through additional structures, such as connecting rods 14 and 15. Specifically, in the embodiment illustrated, the left output shaft 10 is connected with the left rear wheel shaft 5 through the left connecting rod 14, and the right output shaft 11 is connected with the right rear wheel shaft 7 by the right connecting rod 15. Specifically, the structures of the left connecting rod 14 and the right connecting rod 15 are the same or similar, and the left connecting rod 14 is now used as an example for specific description. As shown in FIGS. 4-6, the left connecting rod 14 has a hollow cavity extending in a direction from left to right. The left rear wheel shaft 5 is arranged in the left area of the hollow cavity of the left connecting rod 14 while and the left output shaft 10 is arranged in the right area of the hollow cavity of the left connecting rod 14, so that the left rear wheel shaft 5 and the left output shaft 10 can be co-axially aligned. Additionally, the left rear wheel shaft may be arranged within the hollow cavity of the left connecting rod 14 in a way that integrates the left rear wheel shaft 5 and the left connecting rod 14 i together as a whole such that rotation of one (e.g., the left connecting rod 14) causes rotation of the other (e.g., the left rear wheel shaft 5).

This electric drive mechanism 4 also comprises a housing 20, which may be arranged on frame 1. As shown in FIG. 3, various parts described, such as the motor 9, the left connecting rod 14, and the right connecting rod 15 may all arranged in the housing 20 to create a more compact structure. Such a compact structure may not only be aesthetically pleasing but the compact nature may result in reduced draft.

Embodiments of the left clutch 12 and the right clutch 13 may be overrunning (or freewheeling) clutches in that the left clutch 12 and the right clutch 13 may each drive rotation of the left and right rear wheel shafts 5 and 7 in one direction through use of the motor 9 while allowing free rotation in the other direction. In embodiments shown in FIGS. 4-6, each of the left clutch 12 and the right clutch 13 include a first connecting member 16, a clutch plate 17, a second connecting member 18, a first biasing member 21 (which may also be referred to as a first elastic member), a second biasing member 22 (which may also be referred to as a second elastic member), a friction member 23, and a limiting member 230. The structure of the left clutch 12 is described below as an example, and it should be understood that such description applies to the right clutch 13. Additionally, while some of these components are shown as separate pieces, it will be appreciated that at least some of them may be combined to be a single piece, such as the second connecting member 18 and the friction member 23 (e.g., a single piece may have a first portion that forms the second connecting member 18 and a second portion, integral with the first portion, that forms the friction member 23).

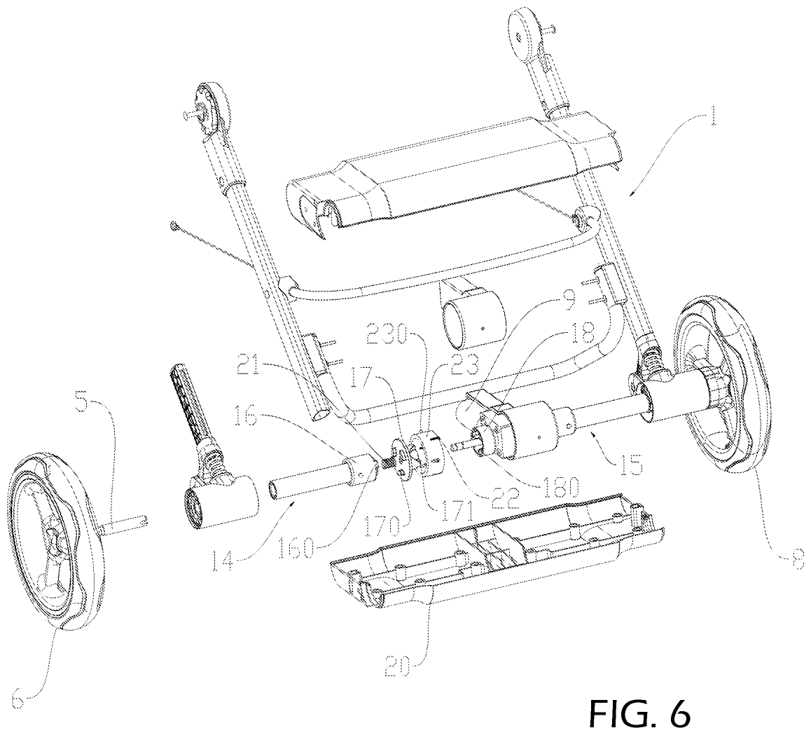

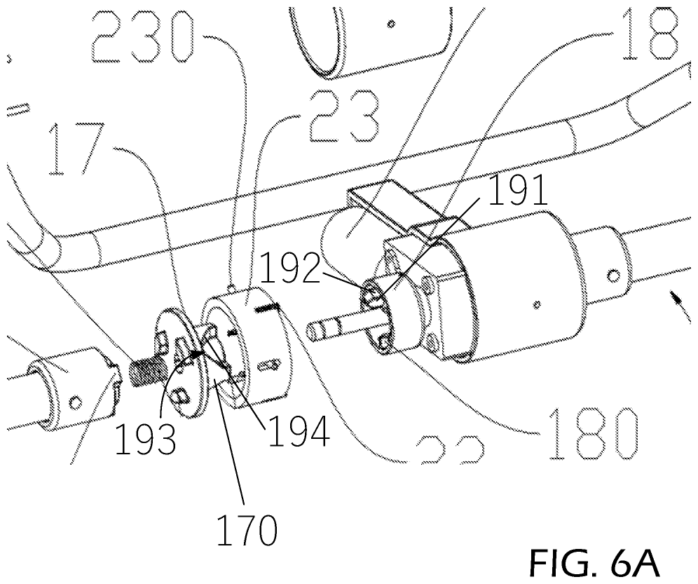

As shown in FIG. 6, the first connecting member 16 is configured to secure the left connecting rod 14 (and consequently the left rear wheel shaft 5) to the left clutch 12. The left rear wheel shaft 5, the left connecting rod 14, and the first connecting member 16 are configured to rotate together as a whole.

The first connecting member 16 has a first end generally oriented towards the motor 9 and an opposite second end generally oriented towards the left rear wheel 6. The first end of the first connecting member 16 engages with a clutch plate 17, which is also connected to the friction member 23. The clutch plate 17 engaged with the first connecting member 16 on one side and the friction member 23 on the other side in a way such that the clutch plate 17 is configured to move axially (or traverse) towards or away from the first connecting member 16 as described further below. Such traverse movement of the clutch plate 17 in an axial direction causes the left rear wheel shaft 5 and the left output shaft 10 to be engaged in some instances and disengaged in other instances.

As illustrated, the first connecting member 16, on the first end, includes a first engaging portion 160 that cooperates with a second engaging portion 170 on the outside of the clutch plate 17. The first engaging portion 160 and the second engaging portion 170 may have structures configured to mate together to create mechanical interference when either the first connecting member 16 or the clutch plate 17 is rotated. For example, the first engaging portion 160 on the first connecting member 16 may include one or more protrusions, while the second engaging portion 170 may include one or more slots or indentions for receiving the protrusions. When the protrusions of the first engaging portion 160 are received within the slots or indentions of the second engaging portion 170 such that the two components are secured through at least mechanical interference such that rotation of either the first connecting member 16 or the clutch plate 17 drives rotation of the other one.

The opposite side (or inside) of the clutch plate 17 engages with the second connecting member 18, which is connected to the left output shaft 10, as well as engages with the friction member 23. Particularly, the inside of the clutch plate 17 includes a first guide surface 171 that cooperates with a second guide surface 180 of the second connecting member 18 as described further below.

The left output shaft 10 is configured to rotate under the drive of the motor 9, which in turn causes the second connecting piece (connected to the left output shaft 10) to rotate. The second guide surface 180 on the second connecting member 18 faces towards the first guide surface 171 of the first connecting member 16 on the clutch plate 17. A close up view of the first guide surface 171 and the second guide surface 180 is provided in FIG. 6A. The second guide surface 180 is formed of angled faces or surfaces 192 of at least one proud member 191 positioned within a cavity of the second connecting member 18. These angled faces 192 forming the second guide surface 180 extend diagonally from a left side (or outside) of the second connecting member 18 down in a direction towards (but not necessarily extending to) the right side (or inside) of the second connecting member 18. Each proud member 191 may include two angled faces 192 (on each side) that mirror each other. Although only one proud member 191 member with angled faces 192 is labeled in FIG. 6A, embodiments may have a plurality of such members.

The first guide surface 171 includes slots 193, where each side of a slot 193 has angled faces 194 extending diagonally inward from a right side (or inside) of the clutch plate 17 to the left side (or outside) of the clutch plate 17. The two angled faces 194 of each slot 193 may mirror each other. There may be enough slots 193 forming the first guide surface 171 to cooperate with each proud member 191 of the second guide surface 180. When the first guide surface 171 is engaged with the second guide surface 180, a proud member 191 is received within a slot 193 such that there may be mechanical interface within at least one of the angled faces 192 with at least one of the angled faces 194 of the slot 193. The angled nature of faces 194 as well as faces 192 cause rotation of the second connecting member 18 (which is driven by the motor 9 via the left output shaft 10) to cause the clutch plate 17 to be pushed (i.e., move transversely) towards the left, or towards the left rear wheel shaft 5. As the clutch plate 17 moves transversely in this matter, the clutch plate 17 may be moving along the left output shaft 10. As the clutch plate 17 traverses along the axial direction, the second engaging portion 170 on the opposite side (the outside) of the clutch plate 17 becomes engaged with the first engaging portion 160 of the first connecting member 16 to cause rotation of the first connecting member 16, the left rear wheel shaft 5 and ultimately the left rear wheel 6 as previously described.

Without the driving force of the second guide surface 180 on the first guide surface 170 of the clutch plate 17, the clutch plate 17 may be biased to move axially away from the first connecting member 16. In one example, a first biasing member 21 is arranged between the first connecting member 16 and the clutch plate 17. The first biasing member 21 may be a coil spring. In other embodiments, the first biasing member 21 may be any other type of spring (e.g., leaf spring) or flexible element. When arranged between the first connecting member 16 and the clutch plate 17, the first biasing member 21 is in a compressed state and pushes the clutch plate 17 away from the first connecting member 16 so that the first engaging portion 160 on the first connecting member 16 is disengaged from the second engaging portion 170 on the clutch plate 17 so that movement of the left rear wheel 6 is not driven by the motor 9. Axial movement of the clutch plate 17 via the interaction of the first guide surface 171 and the second guide surface 180 overcomes the bias of the first biasing member 21 to engage the first connecting member 16 (and therefore the left rear wheel shaft 5) when the motor 9 is driving rotation as described above. Because the first biasing member 21 is compressed, it plays a reset role to reset the position of the clutch plate 17 to a disengaged state when the motor 9 is powered off or not in an electric rotation state.

In embodiments, such as the one shown, the first guide surface 171 of the clutch plate 17 includes angled surfaces 194 on both sides of the slots 193. Angled faces 194 on both sides of a slot 193 allows the motor 9 to drive rotation of the left rear wheel 6 in two directions. Rotation of the left output shaft 10 in a first direction, causes one angled face 192 on the second connecting member 18 to contact one angled face 194 within a slot 193 of the clutch plate 17 to rotate the left rear wheel 6 in the first direction, while rotation of the left output shaft 10 in an opposite second direction causes an opposite angled face 192 on the second connecting member 18 to contact the opposite angled face 194 within the slot 193 to rotate the left rear wheel 6 in the second direction. In this way, embodiments of this disclosure include the motor 9 driving rotation of the rear wheels 6 and 8 such that the motor 9 may be used to move the wheeled child carrier 100 forward or backwards.

In example aspects, rotation of the clutch plate 17, in either direction, may be limited by one or more mechanisms to enable the clutch plate 17 to be moved axially instead of only rotating. In some examples, such as the one illustrated, friction is applied to the clutch plate 17 to limit rotation, although it may be appreciated that other means of limiting rotation may be conceived. As previously indicated, the left clutch 12 of the illustrated embodiment includes a friction member 23 that extends at least partially around the clutch plate 17. For example, the friction member 23 may be sleeved on part of the clutch plate 17 as may also be sleeved on the second connecting member 18. The second biasing member 22, which may be a coil spring or any of type of spring or flexible member, is arranged between the friction member 23 and the motor housing 19 so that one end of the second biasing member 22 is fixedly connected to the friction piece 23 and the other end is fixedly connected to the motor housing 19. The second biasing member 22 is fixed to the friction piece 23 and the motor housing 19 while in a compressed state, thereby causing the friction piece 23 to press down on the clutch plate 17 by the elastic force of the second biasing member 22. In this way, friction is created between the friction piece 23 and the clutch plate 17 that limits the rotation of the clutch plate 17 around the left output shaft 10 of the motor 9. Additionally, rotation of the friction member 23 may also be limited. In this example, the outside wall of the friction member 23 includes a limiting groove 231 that receives a limiting member 230 arranged on the motor housing 19 so that interference between the limiting member 230 and the side of the limiting groove 231 prevents rotation beyond the length of the limiting groove 231.

The structure and functioning of the right clutch 13 is similar to that of the left clutch 12, and will not be repeated here.

As previously described, when the motor 9 is in the electric rotation state, the second connecting member 18 arranged on the left output shaft 10 rotates with the left output shaft 10, and the second guide surface 180 on the second connecting member 18 connects with the first guide surface 171 on the clutch plate 17 in a way so that the clutch plate 17 moves toward the left rear wheel shaft 5 along the left output shaft 10, thereby compressing the first biasing member 21. Meanwhile, the clutch plate 17 may be moving under the limiting action of a friction member 23. Clutch plate 17 may be separated from the friction member 23 until the second engaging portion 170 on the clutch plate 17 engages with the first engaging portion 160 on the first connecting member 16 (as shown in FIG. 4). At this time, the left clutch 12 is in the engaged state (which may be referred to as a first state herein), and the left rear wheel 6 is driven to rotate through the integral rotation of the first connecting member 16, the left connecting rod 14, and the left rear wheel shaft 5.

When the motor 9 is switched from the energized rotation state to the power-off or stall state, under the elasticity (reset) action of the first biasing member 21, the first engaging portion 160 on the first connecting member 16 and the second engaging portion 170 on the clutch plate 17 become disengaged with one another (as shown in FIG. 5) as the clutch plate 17 moves along the axial direction of the left output shaft 10 and approaches the second connecting member 18. At this time, the left clutch 12 is in the disengaged state, which may be referred to as the second state herein.

In embodiments herein, freewheel rotation may be allowed when the motor 9 is in the state of energized rotation or de-energized and stalled state. That is, if the rotational speed of a rear wheel shaft 5 or 6 is greater than the rotational speed of the corresponding output shaft 10 or 11, the corresponding clutch 12 or 13 becomes disengaged. For example, when the left rear wheel shaft 5 is rotating more quickly than the left output shaft 10 (either due to turning of the wheeled child carrier 100), the second guide surface 180 of the second connecting member 18 does not contact the first guide surface 171 of the clutch plate 17 in a way to drive axial movement so that the elasticity of the first biasing member 21 takes over so that the clutch plate 17 moves away from the first connecting member 16 (and the first engaging portion 160 of the first connecting piece is disengaged from the second engaging portion 170 of the clutch plate 17. At this time, the wheeled child carrier 100 can be turned to the right without becoming strenuous due to being subjected to the resistance of the motor 9. Further, disengaging a clutch on one side to allow for easier steering occurs when there is a difference in rotational speed of wheel and output shafts, but it is triggered by the mechanical process disclosed above and not through additional sensors or circuitry, which reduces costs. Turning the cart to the left is the same as turning the cart to the right, and details will not be repeated here.

When the motor 9 is in the electric rotation state and the wheeled child carrier 100 is moving straight, as shown in FIG. 4, the left clutch 12 and the right clutch 13 are in the first (engaged)state, and the left output shaft 10 drives the left rear wheel shaft 5 to rotate through the left clutch 12. At the same time, the right output shaft 11 drives the right rear wheel shaft 7 to rotate through the right clutch 13, so that the motor 9 provides power assistance for the advancement of the wheeled child carrier 100.

When the motor 9 is in the energized rotation state and the front wheel 3 turns to the left, the left output shaft 10 is the driving shaft, the left clutch 12 remains in the first (engaged) state so that the left output shaft 10 drives the left rear wheel shaft 5 to rotate through the left clutch 12, and then drive the left rear wheel 104 to rotate. However, because the wheeled child carrier 100 is to turn to the left, the radius of rotation of the left rear wheel 6 is less than the radius of rotation of the right rear wheel 8, causing the rotating speed of the right rear wheel shaft 7 to be greater than the rotating speed of the right output shaft 11, thereby causing disengaged between the right clutch 13 in the manner described above for example. The right clutch 13 would, therefore, be in the second (disengaged) state.

Conversely, when the motor 9 is in the state of being powered and the front wheel 3 turns to the right, the right output shaft 11 becomes the driving shaft, and the right clutch 13 remains in the first state so that the right output shaft 11 drives the right rear wheel shaft 7 to rotate through the right clutch 13, and then drive the right rear wheel 8 to rotate. Because the wheeled child carrier 100 is turning to the right, the radius of rotation of the right rear wheel 8 is less than the radius of rotation of the left rear wheel 6, causing the rotating speed of the left rear wheel shaft 5 to be greater than the rotating speed of the left output shaft 10, thereby disengaging the left clutch 12 in the manner described above for example. The left clutch 12 would, therefore, be in the second (disengaged) state.

When the motor is in the power-off stall state and a user is pushing the wheeled child carrier 100, as shown in FIG. 5, the left rear wheel shaft 5 is the driving shaft on the left side and the right rear wheel shaft 7 is the driving shaft on the right side. As such, the left clutch 12 and the right clutch 13 are each in the second (disengaged state). In this way, a user can directly move (e.g., push or pull) the wheeled child carrier 100 by the external push or pull force and disengagement of the clutches 12 and 13 reduces or removes resistance from the motor 9, thereby making this manual movement of the wheeled child carrier 100 easier on the user compared to other electric assistance options.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting:
Clause 1: An electric power-assisted wheeled child carrier comprising: a frame; a plurality of wheels joined to the frame; and an electric drive mechanism for electrically powering rotation of at least one wheel of the plurality of wheels, the electric drive mechanism comprising: a motor, an output shaft coupled to the motor, wherein the motor is configured to rotate the output shaft, a wheel shaft coupled to the at least one wheel, and a clutch positioned between the output shaft and the wheel shaft, wherein the clutch is configured to move axially between an engaged state and a disengaged state, wherein in the engaged state, the output shaft powered by the motor drives rotation of the at least one wheel and in the disengaged state, the at least one wheel is configured to rotate without power from the motor.
Clause 2: The electric power-assisted wheeled child carrier of clause 1, wherein the clutch is configured to move to the disengaged state when the motor is powered off.
Clause 3: The electric power-assisted wheeled child carrier of any of clauses 1-2, wherein the clutch is configured to move from the engaged state to the disengaged state when the rotational speed of the wheel shaft is greater than the rotational speed of the output shaft.
Clause 4: The electric power-assisted wheeled child carrier of any of clauses 1-2, wherein the at least one wheel is a left rear wheel and the plurality of wheels further includes a right rear wheel.
Clause 5: The electric power-assisted wheeled child carrier of clause 4, wherein the output shaft is a left output shaft, the wheel shaft is a left rear wheel shaft, and the clutch is a left clutch, wherein the electric drive mechanism further includes: a right output shaft coupled to the motor and configured to be rotated by the motor, a right rear wheel shaft coupled to the right rear wheel, and a right clutch positioned between the right output shaft and the right rear wheel shaft, wherein the right clutch is configured to move axially between an engaged state and a disengaged state, wherein in the engaged state, the right output shaft powered by the motor drives rotation of the right rear wheel and in the disengaged state, the right rear wheel is configured to rotate without power from the motor.
Clause 6: The electric power-assisted wheeled child carrier of clause 5, wherein when the electric power-assisted wheeled child carrier is turning left, the left clutch is in the engaged state and the right clutch is in the disengaged state.
Clause 7: The electric power-assisted wheeled child carrier of any of clauses 5-6, wherein when the electric power-assisted wheeled child carrier is turning right, the right clutch is in the engaged state and the left clutch is in the disengaged state.
Clause 8: The electric power-assisted wheeled child carrier of any of clauses 5-7, wherein the left clutch and the right clutch are each configured to move to the disengaged state when the motor is powered off and the left rear wheel and the right rear wheel are being rotated.
Clause 9: The electric power-assisted wheeled child carrier of any of clauses 1-8 further comprising a storage battery for providing electric power to the motor.
Clause 10: The electric power-assisted wheeled child carrier of any of clauses 1-9, wherein the clutch is configured to move axially along the output shaft.
Clause 11: The electric power-assisted wheeled child carrier of any of clauses 1-10, wherein the electric drive mechanism further includes: a first connecting piece joined with the wheel shaft and having an engaging portion configured to engage with a first side of the clutch when the clutch is in the engaged state, and a second connecting piece joined with the output shaft and having one or more guide surfaces configured to cooperate with at least one angled face on a second side of the clutch that is opposite the first side.
Clause 12: The electric power-assisted wheeled child carrier of clause 11, wherein the at least one angled face includes a first face and a second face, each angled diagonally in opposite directions as one another, wherein a first surface of the one or more guide surfaces is configured to contact the first face of the clutch when the output shaft is rotating in a first direction, and wherein a second surface of the one or more guide surfaces is configured to contact the second face of the clutch when the output shaft is rotating in a second direction.
Clause 13: An electric power-assisted wheeled child carrier comprising: a frame; a left rear wheel and a right rear wheel connected to the frame; and an electric drive mechanism for electrically powering rotation of the left rear wheel and the right rear wheel, the electric drive mechanism comprising: a motor, a left output shaft and a right output shaft each coupled to the motor and configured to be rotated by the motor, a left rear wheel shaft coupled to the left rear wheel, and a right rear wheel shaft coupled to the right rear wheel, and a left clutch joining the left output shaft and the left rear wheel shaft, and a right clutch joining the right output shaft and the right rear wheel shaft, wherein the left clutch and the right clutch are each an overrunning clutch.
Clause 14: The electric power-assisted wheeled child carrier of clause 13, wherein the left output shaft, the right output shaft, the left rear wheel shaft, and the right rear wheel shaft are all coaxially aligned.
Clause 15: The electric power-assisted wheeled child carrier of any of clauses 13-14, wherein the electric power-assisted wheeled child carrier is a stroller.
Clause 16: The electric power-assisted wheeled child carrier of any of clauses 13-15 further comprising at least one front wheel.
Clause 17: The electric power-assisted wheeled child carrier of any of clauses 13-15, wherein the electric drive mechanism further includes a biasing element configured to bias the left clutch away from the left rear wheel shaft.
Clause 18: The electric power-assisted wheeled child carrier of clause 17, wherein the bias of the biasing element is overcome so that the left clutch is moved towards the left rear wheel shaft when a rotational speed of the left output shaft is greater than a rotational speed of the left rear wheel shaft.
Clause 19: An electric power-assisted stroller comprising: a frame defining a seating area; a handle joined to an upper portion of the frame; a left rear wheel and a right rear wheel, each connected to the frame; and an electric drive mechanism for electrically powering rotation of the left rear wheel and the right rear wheel, the electric drive mechanism comprising: a motor, a left output shaft and a right output shaft each coupled to the motor and configured to be rotated by the motor, a left rear wheel shaft coupled to the left rear wheel, and a right rear wheel shaft coupled to the right rear wheel, and a left clutch joining the left output shaft and the left rear wheel shaft, and a right clutch joining the right output shaft and the right rear wheel shaft, the left clutch and the right clutch each configured to move axially, wherein the left clutch is biased toward the left output shaft when the left rear wheel shaft is rotating more quickly than the left output shaft and wherein the right clutch is biased toward the right output shaft when the right rear wheel shaft is rotating more quickly than the right output shaft.
Clause 20: The electric power-assisted stroller of claim 19, wherein when the motor is powered on and at least one front wheel of the electric power-assisted stroller is turned left, the right clutch moves to a disengaged state while the left clutch remains in an engaged state.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

What is claims is:

1. An electric power-assisted wheeled child carrier comprising:
a frame;
a plurality of wheels joined to the frame; and
an electric drive mechanism for electrically powering rotation of at least one wheel of the plurality of wheels, the electric drive mechanism comprising:
a motor,
an output shaft coupled to the motor, wherein the motor is configured to rotate the output shaft,
a wheel shaft coupled to the at least one wheel, and
a clutch positioned between the output shaft and the wheel shaft, wherein the clutch is configured to move axially between an engaged state and a disengaged state, wherein in the engaged state, the output shaft powered by the motor drives rotation of the at least one wheel and in the disengaged state, the at least one wheel is configured to rotate without power from the motor.

2. The electric power-assisted wheeled child carrier of claim 1, wherein the clutch is configured to move to the disengaged state when the motor is powered off.

3. The electric power-assisted wheeled child carrier of claim 1, wherein the clutch is configured to move from the engaged state to the disengaged state when the rotational speed of the wheel shaft is greater than the rotational speed of the output shaft.

4. The electric power-assisted wheeled child carrier of claim 1, wherein the at least one wheel is a left rear wheel and the plurality of wheels further includes a right rear wheel.

5. The electric power-assisted wheeled child carrier of claim 4, wherein the output shaft is a left output shaft, the wheel shaft is a left rear wheel shaft, and the clutch is a left clutch, wherein the electric drive mechanism further includes:
a right output shaft coupled to the motor and configured to be rotated by the motor,
a right rear wheel shaft coupled to the right rear wheel, and
a right clutch positioned between the right output shaft and the right rear wheel shaft, wherein the right clutch is configured to move axially between an engaged state and a disengaged state, wherein in the engaged state, the right output shaft powered by the motor drives rotation of the right rear wheel and in the disengaged state, the right rear wheel is configured to rotate without power from the motor.

6. The electric power-assisted wheeled child carrier of claim 5, wherein when the electric power-assisted wheeled child carrier is turning left, the left clutch is in the engaged state and the right clutch is in the disengaged state.

7. The electric power-assisted wheeled child carrier of claim 5, wherein when the electric power-assisted wheeled child carrier is turning right, the right clutch is in the engaged state and the left clutch is in the disengaged state.

8. The electric power-assisted wheeled child carrier of claim 5, wherein the left clutch and the right clutch are each configured to move to the disengaged state when the motor is powered off and the left rear wheel and the right rear wheel are being rotated.

9. The electric power-assisted wheeled child carrier of claim 1 further comprising a storage battery for providing electric power to the motor.

10. The electric power-assisted wheeled child carrier of claim 1, wherein the clutch is configured to move axially along the output shaft.

11. The electric power-assisted wheeled child carrier of claim 1, wherein the electric drive mechanism further includes:
a first connecting piece joined with the wheel shaft and having an engaging portion configured to engage with a first side of the clutch when the clutch is in the engaged state, and
a second connecting piece joined with the output shaft and having one or more guide surfaces configured to cooperate with at least one angled face on a second side of the clutch that is opposite the first side.

12. The electric power-assisted wheeled child carrier of claim 11, wherein the at least one angled face includes a first face and a second face, each angled diagonally in opposite directions as one another, wherein a first surface of the one or more guide surfaces is configured to contact the first face of the clutch when the output shaft is rotating in a first direction, and wherein a second surface of the one or more guide surfaces is configured to contact the second face of the clutch when the output shaft is rotating in a second direction.

13. An electric power-assisted wheeled child carrier comprising:
a frame;
a left rear wheel and a right rear wheel connected to the frame; and
an electric drive mechanism for electrically powering rotation of the left rear wheel and the right rear wheel, the electric drive mechanism comprising:
a motor,
a left output shaft and a right output shaft each coupled to the motor and configured to be rotated by the motor,
a left rear wheel shaft coupled to the left rear wheel, and a right rear wheel shaft coupled to the right rear wheel, and
a left clutch joining the left output shaft and the left rear wheel shaft, and a right clutch joining the right output shaft and the right rear wheel shaft, wherein the left clutch and the right clutch are each an overrunning clutch.

14. The electric power-assisted wheeled child carrier of claim 13, wherein the left output shaft, the right output shaft, the left rear wheel shaft, and the right rear wheel shaft are all coaxially aligned.

15. The electric power-assisted wheeled child carrier of claim 13, wherein the electric power-assisted wheeled child carrier is a stroller.

16. The electric power-assisted wheeled child carrier of claim 13 further comprising at least one front wheel.

17. The electric power-assisted wheeled child carrier of claim 13, wherein the electric drive mechanism further includes a biasing element configured to bias the left clutch away from the left rear wheel shaft.

18. The electric power-assisted wheeled child carrier of claim 17, wherein the bias of the biasing element is overcome so that the left clutch is moved towards the left rear wheel shaft when a rotational speed of the left output shaft is greater than a rotational speed of the left rear wheel shaft.

19. An electric power-assisted stroller comprising:
a frame defining a seating area;
a handle joined to an upper portion of the frame;
a left rear wheel and a right rear wheel, each connected to the frame; and
an electric drive mechanism for electrically powering rotation of the left rear wheel and the right rear wheel, the electric drive mechanism comprising:
a motor,
a left output shaft and a right output shaft each coupled to the motor and configured to be rotated by the motor,
a left rear wheel shaft coupled to the left rear wheel, and a right rear wheel shaft coupled to the right rear wheel, and
a left clutch joining the left output shaft and the left rear wheel shaft, and a right clutch joining the right output shaft and the right rear wheel shaft, the left clutch and the right clutch each configured to move axially,
wherein the left clutch is biased toward the left output shaft when the left rear wheel shaft is rotating more quickly than the left output shaft and wherein the right clutch is biased toward the right output shaft when the right rear wheel shaft is rotating more quickly than the right output shaft.

20. The electric power-assisted stroller of claim 19, wherein when the motor is powered on and at least one front wheel of the electric power-assisted stroller is turned left, the right clutch moves to a disengaged state while the left clutch remains in an engaged state.
